(19) United States
(12) Patent Application Publication
(10) Pub. No.: US 2004/0112663 A1
(43) Pub. Date: Jun. 17, 2004

(54) Method and device for recognition of a side impact on a motor vehicle

(76) Inventors: Pascal Kocher, Gerlingen (DE); Isolde Simon, Kusterdingen (DE); Michael Arndt, Reutlingen (DE); Rolf-Juergen Recknagel, Jena (DE); Rolf Aidam, Endingen (DE)

Correspondence Address: KENYON & KENYON, ONE BROADWAY, NEW YORK, NY, 10004, US

(21) Appl. No.: 10/415,543

(22) PCT Filed: Jul. 30, 2002
(86) PCT No.: PCT/DE02/02792

(30) Foreign Application Priority Data
Aug. 29, 2001 (DE) 101 42 173.7

(51) Int. Cl. B60R 21/01

(52) U.S. Cl. 180/274

(57) ABSTRACT

A method and a device are described for detecting a side impact on a motor vehicle.

In order to ensure accurate detection of a side impact and to also ensure the operativeness of the device and the method, a device is proposed having

a temperature sensor (6) provided in an enclosed air volume inside a door;

a heating device (4, 14, 21, 22) provided in the enclosed air volume;

a measuring device (15) for receiving and conditioning a measuring signal of the temperature sensor (6) and outputting a temperature signal;

a heat generator (17) for activating the heating device (4), and

an analysis and control device (16) for receiving the temperature signal of the measuring device (15) and activating the heat generator (17).

The present invention relates to a method and a device for detecting a side impact on a motor vehicle.

Detection of a side impact on a motor vehicle in the area of the passenger compartment is important in particular for the deployment of the side airbag. Various systems are known for this purpose. According to one approach, acceleration sensors directly measuring the acceleration that occurs during deformation of the door are mounted on the doors. In another approach, devices and methods are known in which a pressure sensor is mounted in an enclosed air volume inside the door and measures the reduction of air volume as a pressure increase in the event of an impact. The pressure measuring signal of the pressure sensor is tested by an analyzer in particular regarding whether a sufficiently rapid pressure increase is present which is identified as a side impact.

The disadvantage of the known devices and methods is that the availability of the sensor provided in the vehicle door cannot be tested without disassembling the door. Servicing the device for side impact detection or testing for availability is thus virtually impossible.

The device according to the present invention having the features of claim 1 and the method according to the present invention having the features of claim 11 offer the advantage compared to the related art that a reliable and rapid detection of a side impact is ensured and a self-test of the device and the method may be performed to ensure its availability.

Thus, according to the present invention, the temperature increase occurring in the event of a side impact due to the reduction of air volume inside the door is measured. Because in the event of a side impact a sudden, and therefore almost adiabatic, compression of the air occurs in the air volume, during which the heat energy transferred from the air to the door is virtually negligible, a side impact is reliably detectable. In contrast with acceleration measuring methods or pressure measuring methods, this temperature increase occurring in the event of a side impact may be simulated with relatively little complexity, yet reliably in a self-test by causing a temperature increase at least in the area of the temperature sensor using a heating device. Such a self-test is advantageously possible at any time without impairing the availability or service life of the temperature sensor.

The measuring signal of the temperature sensor is recorded by a measuring device which relays a temperature signal to a control and analysis unit, optionally after signal conditioning. The control and analysis unit in turn sends control signals to perform a self-test to a heat generator, which activates the heating device. Thus the heating operation and the temperature measurement may be coordinated; in particular, the timing and/or heat intensity may be varied and the intensity and timing of the measuring signal, in particular including a time delay with respect to the heating operation and its flank steepness may be analyzed. For example, the steepness and delay of the measuring signal may be detected in the event of a sudden temperature increase generated by a square-wave pulse.

The temperature may be measured by different temperature sensors. In particular, resistive measurements may be made using a resistor element made of a material whose resistance has a high temperature coefficient. In order to permit a rapid response of the resistor element to a temperature increase of the surrounding air, its surface exposed to the air volume is advantageously designed to be large compared to its layer thickness. Thin layers applied to a substrate may therefore be used in particular. Thermal insulation of at least a relatively large area of the measuring resistor with respect to its attachment points to increase the accuracy of measurement and to achieve more rapid response characteristics is advantageous here. This may be achieved in particular by forming meander-shaped layers or paths on a thin area of a substrate designed as a thermally insulating membrane.

Heat energy may be supplied to the temperature sensor via the heating device in different ways, for example, by heat conduction, convection, or heat radiation. For high accuracy of the self-test for availability, a rapid temperature increase in the area of the temperature sensor is advantageous.

When heating by heat conduction, the heating device is provided on the substrate, where the temperature sensor is also mounted. Rapid temperature increase is achieved in particular in this case due to the fact that the heating device is provided in the immediate proximity of the temperature sensor on the membrane, for example, as a heating resistor layer parallel to the measuring resistor layer. The fact that the measuring resistor layer and the heating resistor layer are of the same type and of a symmetrical or at least similar design also permits optionally switching between the resistor layers, so that increased reliability of the self-test is achieved. In the event of failure of the temperature resistor layer, the heating resistor layer may always continue to be used as a temperature sensor.

Heat energy may also be supplied by heat conduction of the substrate via a heating resistor layer provided outside the membrane, which permits a more cost-effective design. In both cases, the connection between the heating device and the heat generator and between the temperature sensor and the measuring device may be implemented via appropriate terminal contacts or bond pads on the chip, which allows simple replacement of a defective device by replacing this chip.

Heat energy may also be supplied by convection in that the heating device, for example, as a heating resistor, heats air underneath the temperature sensor, and the heated air flows alongside the temperature sensor. Heat may be supplied by heat radiation via an infrared LED directed at the temperature sensor, for example.

Impairment of availability due to contamination or deposits on the temperature sensor may be detected as a time delay and lower measured temperature. Pulsating heating by the heating device may be used in particular for this purpose, thus testing the dynamic response of the temperature sensor.

The present invention is elucidated below with reference to some exemplary embodiments illustrated in the drawing.

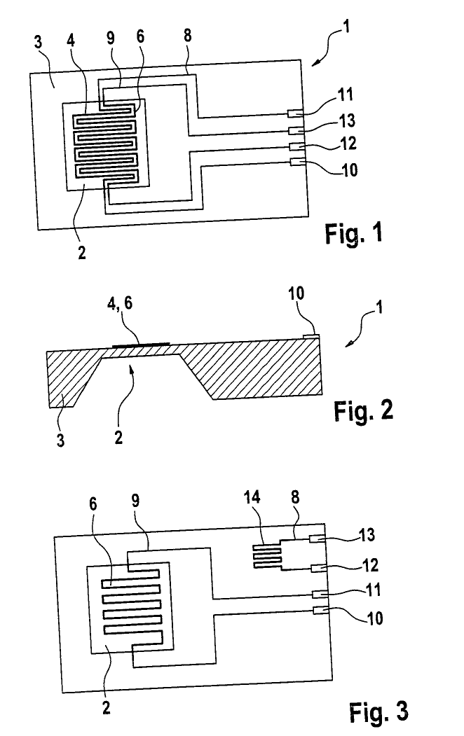

FIG. 1 shows a top view of a chip having an integrated temperature sensor and heating device according to one embodiment of the present invention;

FIG. 2 shows a cross-section through the chip of FIG. 1;

FIG. 3 shows a top view of a chip according to an additional embodiment of the present invention;

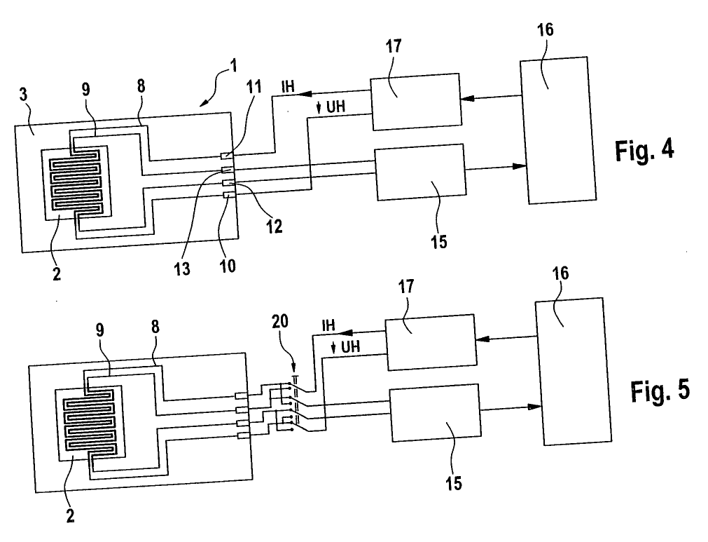

FIG. 4 shows a side impact detection device having the circuit of FIG. 1 according to one embodiment of the present invention;

FIG. 5 shows a side impact detection device having the circuit of FIG. 1 according to an additional embodiment of the present invention;

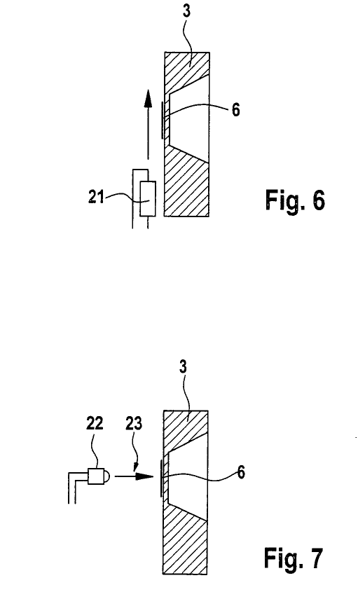

FIG. 6 shows a sectional view of a system made up of a temperature sensor and a heating device of a side impact detection device according to an additional embodiment of the present invention;

FIG. 7 shows a sectional view of a system made up of a temperature sensor and a heating device of a side impact detection device according to an additional embodiment of the present invention.

According to FIG. 1 and FIG. 2, a measuring device I has a substrate 3 made of silicon, for example, in which a membrane 2 is formed as a thin area by an etched recess on the underside. A meander-shaped heating resistor layer 4 and a meander-shaped temperature resistor layer 6, which are nested in each other for effective utilization of the surface areas of membrane 2, are provided on membrane 2. Temperature measuring resistor layer 6 and heating resistor layer 4 are each made of a thin metal layer or semiconductor layer, applied to an insulator layer (not shown) on substrate 3 and membrane 2. Outside membrane 2, these layers, which may have a modified thickness and width, are designed as leads 8, 9 to terminal contacts, i.e., bond pads 10, 11, 12, 13. A change in temperature is detected as a change in the resistance between terminal contacts 10, 11, and heat energy is supplied to terminal contacts 12 and 13 via heating resistor layer 6 by connecting a current source or voltage source to terminal contacts 12 and 13.

In the embodiment of FIG. 3, temperature measuring resistor layer 6 is also formed on membrane 2 and connected to terminal contacts 10, 11 at the edge of the chip via leads 9. The heating device according to the present invention is, however, formed by a heating resistor layer 14, which is provided on an insulator layer on substrate 3 outside membrane 2, also has a meander-shaped design, and is connected to terminal contacts 12 and 13 via leads 8. The manufacturing costs of such a measuring device are reduced compared to those of the device shown in FIGS. 1 and 2; however, heat conduction via the thicker substrate 3 and membrane 2 to temperature measuring resistor layer 6 is somewhat delayed, so that the temperature increase determined by temperature measuring resistor layer 6 has a less steep signal slope and is somewhat delayed due to the inertia of the thicker substrate 3.

Measuring device 1 of FIGS. 1 and 3 may be activated and analyzed using the external circuitry shown in FIG. 4 or 5. According to FIG. 4, the temperature is measured regularly using a measuring device 15, which measures the electrical resistance between terminal contacts 12 and 13 as a voltage drop and outputs a temperature signal to a control and analysis device 16 by signal conditioning. On the basis of the measured temperature and, in particular, the time characteristics of the temperature signal, control and analysis device 16 determines whether a side impact has occurred, for example, by forming the derivative over time of the measured temperature signal and comparing it with the predefined reference and threshold values, on the basis of a rapid and sufficient increase in the measured temperature, whereupon an appropriate control signal is output to a side airbag or a data bus of the motor vehicle, for example.

To perform a self-test, for example, at the time of starting the vehicle or in regular time intervals, control and analysis device 16 outputs a control signal to a heat generator 17, which has a current source or a voltage source connected to terminal contacts 10 and 11 of heating resistor layer 4. Applied voltage UH or current IH flowing through heating resistor layer 4 causes the temperature of membrane 2 to rise, and a modified resistance value is picked up by measuring device 15 across terminal contacts 12, 13. Control and analysis device 16 determines the difference in the height of the temperature signal, the time delay between the output of the control signal to heat generator 17 and the change in the temperature signal, and the steepness of the temperature signal. Subsequently a self-test signal is output, for example, to a data bus of the motor vehicle, which indicates the availability of measuring device 1; or, if a fault has been determined, an appropriate error signal may be output.

The construction of FIG. 5 initially corresponds to that of FIG. 4, the terminals of measuring device 15 and heat generator 17 being optionally connectable to terminal contacts 10, 11, or 12, 13 via a switching device 20, so that the circuitry may be reversed with respect to FIG. 4, where temperature measuring resistor layer 6 is used as a heating device and heating resistor layer 4 is used as a temperature sensor. Such a switch may be performed in particular for the self-test, the accuracy of operation of both temperature measuring resistor layer 6 and heating resistor layer 4 being tested via a brief reversal of the circuitry. Furthermore, in the event of a failure of temperature measuring resistor layer 6, heating resistor layer 4 may be used as a temperature sensor, in which case no self-test may be performed.

According to FIG. 6, a heating resistor 21 is connected to a heat generator (not shown) and is provided outside of substrate 3 in the air volume inside the door. Heating resistor 21 is placed so that the air heated by it is guided along temperature sensor 6, which may be achieved in particular by placing it underneath and laterally near temperature sensor 6. This embodiment has the advantage that external heating resistor 21 used as a heating device causes an increase in temperature of the air in the air volume as is also to be measured in the event of a side impact. Should temperature sensor 6 fail to sense the change in temperature or sense it weakly or with a delay due to contamination or a deposit, for example, this is directly detectable in the self-test.

In the embodiment of FIG. 7, the heat is supplied to temperature sensor 6 by heat radiation in that an infrared LED 22 radiates infrared rays onto temperature sensor 6 via a space 23 in the air volume inside the door. Contamination of or a deposit on temperature sensor 6 is detected, also in this embodiment, as a weak or delayed measuring signal through shielding of the heat radiation.

What is claimed is:

1. A device for detecting a side impact on a motor vehicle comprising
a temperature sensor (6) provided in an enclosed air volume inside a door;
a heating device (4, 14, 21, 22) provided in the enclosed air volume;
a measuring device (15) for receiving and conditioning a measuring signal of the temperature sensor (6) and outputting a temperature signal;
a heat generator (17) for activating the heating device (4), and
an analysis and control device (16) for receiving the temperature signal of the measuring device (15) and activating the heat generator (17).

2. The device as recited in claim 1,
wherein the temperature sensor (6) is designed as a meander-shaped temperature resistor layer (6) made of a material having a temperature-dependent resistance, preferably a metal or semiconductor, and exposed to the air volume.

3. The device as recited in claim 1 or 2,
wherein the temperature sensor (6) is provided on a membrane (2) preferably designed as a thin area of a substrate (3).

4. The device as recited in claim 3,
wherein the heating device is provided as a preferably meander-shaped heating resistor layer (4, 14) on the substrate (3).

5. The device as recited in claim 4,
wherein the heating resistor layer (4) is formed on the membrane (2).

6. The device as recited in claim 5,
wherein the temperature resistor layer (6) and the heating resistor layer (4) are applied to the membrane (2) nested into each other in parallel and in a meander shape.

7. The device as recited in claim 6,
wherein a switching device (20) is provided for switching between two switching states, in a first switching state the temperature resistor layer (6) being connected to the measuring device (15) and the heating resistor layer (4) to the heat generator (17), and in a second switching state the temperature resistor layer (6) being connected to the heat generator (17) and the heating resistor layer (4) to the measuring device (15).

8. The device as recited in one of claims 4 through 7,
wherein the temperature resistor layer (6) and the heating resistor layer (4, 14) are connected to the measuring device (15) and the heat generator (17) via terminal contacts (10, 11, 12, 13) provided on the substrate (3).

9. The device as recited in one of claims 1 through 3,
wherein the heating device is designed as a convection heating device (21) positioned outside the substrate (3) and preferably underneath the temperature sensor (6).

10. The device as recited in one of claims 1 through 3,
wherein the heating device is designed as a heat radiating heating device (22), preferably as an infrared LED, and is provided in a manner that it is separated from the temperature sensor (6) via a space (23) in the air volume.

11. A method of detecting a side impact on a vehicle, in which
a temperature is measured in an enclosed air volume inside a door using a temperature sensor (6), and it is decided, on the basis of the measured temperature, whether a side impact has occurred;
a function test being performed at least from time to time in which the air volume and/or the temperature sensor (6) is heated, and it being decided, from a measuring signal of the temperature sensor, whether the temperature sensor (6) is functional.

12. The method as recited in claim 11,
wherein a height and/or a steepness and/or a time delay of the measuring signal is evaluated.

13. The method as recited in claim 11 or 12,
wherein during the function test a switch takes place between two switching states at least from time to time, in a first switching state the temperature being measured by the temperature sensor (6) and heat energy being supplied by a heating device (4), and
in a second switching state the temperature being measured by the heating device (4) and heat energy being supplied by the temperature sensor (6).

14. The method as recited in one of claims 11 through 13,
wherein the heat energy is supplied in pulses at least from time to time, and from a measured temperature increase characteristic it is determined whether the temperature sensor (6) is covered at least at some points.
